(19) United States
(12) Patent Application Publication
(10) Pub. No.: US 2008/0211226 A1
(43) Pub. Date: Sep. 4, 2008

(54) ENHANCED ESCUTCHEON COVER PLATE

(75) Inventor: Charlie E. Whitney, East Wenatchee, WA (US)

Correspondence Address: DAVIS WRIGHT TREMAINE, LLP/Seattle, 1201 Third Avenue, Suite 2200, SEATTLE, WA, 98101-3045, US

(73) Assignee: ACCOR TECHNOLOGY, INC., Bellevue, WA (US)

(21) Appl. No.: 11/681,125

(22) Filed: Mar. 1, 2007

(51) Int. Cl. F16L 5/00

(52) U.S. Cl. 285/46

(57) ABSTRACT

An enhanced escutcheon cover plate includes a plate body and an opening having a periphery and surrounded by the plate body. The enhanced cover plate further includes a flexible portion extending from the plate body along portions of the periphery of the opening. The flexible portion is elastically moveable between a first position and a second position. In the first position, the flexible portion can define a first passageway for piping to be received through the opening. In the second position, the flexible portion can define a second passageway larger than the first passageway. A pipe can be slid through the opening while the flexible portion is in the first position. A compression ferrule affixed to the pipe can be slid through the opening while the flexible portion is in the second position.

### FIELD OF THE INVENTION

This invention is related to pipe hardware.

### BACKGROUND OF THE INVENTION

Pipes such as those coupled to sinks and other fixtures can be located inside of internal walls of residential and commercial buildings. To be coupled with fixtures located outside of the walls, oftentimes a pipe will extend through a hole in the wall that houses the pipe. The hole in the wall can typically be unsightly so that a conventional escutcheon cover plate is used to cover the hole. The escutcheon cover plate has an opening sized large enough for the pipe to extend through it but small enough so that the hole in the wall is sufficiently covered.

The pipe can be coupled to a compression valve of the fixture by affixing a compression ring, also known as a compression ferrule, to the pipe along with a nut as is conventionally known. The nut is then screwed on to the compression valve of the fixture to couple the pipe to a valve. Other methods of coupling pipes to fixtures involve use of push-on valves that couple with the pipe without need of a compression ring or nut being affixed to the pipe.

A problem can occur when a push-on valve is used to replace a compression valve on a pipe having a nut and compression ring that was used to affix the compression valve to the pipe. Generally the compression ring is small enough that the push-on valves can be constructed to be used even if a compression ring is affixed to the pipe as long as there is sufficient length of pipe remaining on the end of the pipe past the compression ring.

However, regarding the nut, the existing escutcheon plate is typically removed so that the nut can be pushed through the hole in the wall to be hid inside of the wall. Unfortunately, even in cases where the new push-on valve will allow the compression ferrule to remain on the pipe, the compression ferrule is in the way of the conventional escutcheon plate. Consequently, in order to install a replacement escutcheon cover plate, the compression ferrule is removed by cutting the pipe, pulling the ferrule and/or cutting the ferrule, which adds extra installation steps.

### BRIEF DESCRIPTION OF THE SEVERAL VIEWS OF THE DRAWING(S)

FIG. 1 is a front perspective view of an enhanced escutcheon cover plate.

FIG. 2 is a rear perspective view of the enhanced cover plate of FIG. 1.

FIG. 3 is a front side elevational view of the enhanced cover plate of FIG. 1.

FIG. 4 is a top plan view of the enhanced cover plate of FIG. 1.

FIG. 5 is a sectional view of the enhanced cover plate taken along the 5-5 line of FIG. 3.

FIG. 6 is a sectional view of the enhanced cover plate taken along the 6-6 line of FIG. 3.

FIG. 7 is a perspective view of the enhanced cover plate of FIG. 1 being installed with a push-on valve to replace a prior installed compression valve.

FIG. 8 is a perspective view of the enhanced cover plate of FIG. 7 showing the cover plate and the push-on valve in an installed position on a pipe.

FIG. 9 is a sectional view of the enhanced cover plate taken along the 9-9 line of FIG. 7 in an initial installation position.

FIG. 10 is a sectional view of the enhanced cover plate in a first installation position.

FIG. 11 is an enlarged partial view of the enhanced cover plate shown in FIG. 10 in the first installation position.

FIG. 12 is a sectional view of the enhanced cover plate is a second installation position.

FIG. 13 is an enlarged partial view of the enhanced cover plate of FIG. 12 in the second installation position.

FIG. 14 is a sectional view of the enhanced cover plate in an installed position.

FIG. 15 is a sectional view of the enhanced cover plate being removed from the pipe.

FIG. 16 is an enlarged partial view of the enhanced cover plate of FIG. 15 being removed from the pipe.

### DETAILED DESCRIPTION OF THE INVENTION

An enhanced escutcheon cover plate is described herein that includes a plate body and an opening having a periphery and surrounded by the plate body. The enhanced cover plate further includes a flexible portion extending from the plate body along portions of the periphery of the opening. The flexible portion is elastically moveable between a first position and a second position. In the first position, the flexible portion can define a first passageway for piping to be received through the opening.

In the second position, the flexible portion can define a second passageway for larger diameter piping to be received through the opening. A pipe can be slid through the opening while the flexible portion is in the first position. The second passageway can be larger than the first passageway so that a compression ferrule affixed to the pipe can be slid through the opening while the flexible portion is in the second position.

In implementations the plate body can have a first thickness and the flexible portion can have a second thickness, where the first thickness is greater than the second thickness. The opening can include a center and the flexible portion can extend inward toward the center of the opening. The plate body can have a curvature and the flexible portion can have a flat surface. The cover plate can have a circular outer periphery.

The flexible portion can extend radially and axially inwardly from the periphery of the opening. The flexible portion can have end portions that border a circular portion of the opening. The flexible portion can also include narrowed end portions. The cover plate can have a center and the opening can have a center and the center of the opening can be the center of the cover plate.

In implementations the flexible portion of the enhanced cover plate can have a plurality of members flexibly coupled to the plate body and spaced along portions of the periphery of the opening to allow for elastic movement of the members between the first position and the second position, The members in the first position can extend from the plate body into the opening to define the first passageway, The members in the second position can extend from the plate body into the opening to define the second passageway. The members can be spaced along the periphery of the opening with gaps between adjacent members. The members can extend radially and axially inwardly from the periphery of the opening. Each of the members can have an end and the ends can be positioned to border a circular portion of the opening to define a passageway. The members can each have ends and each have a width that narrows toward the end.

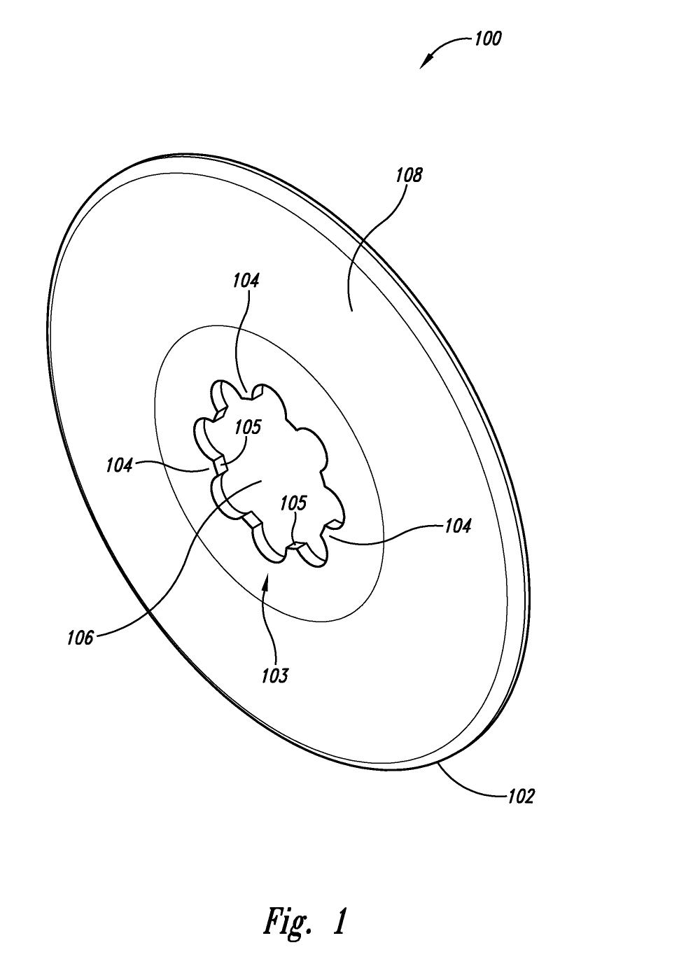

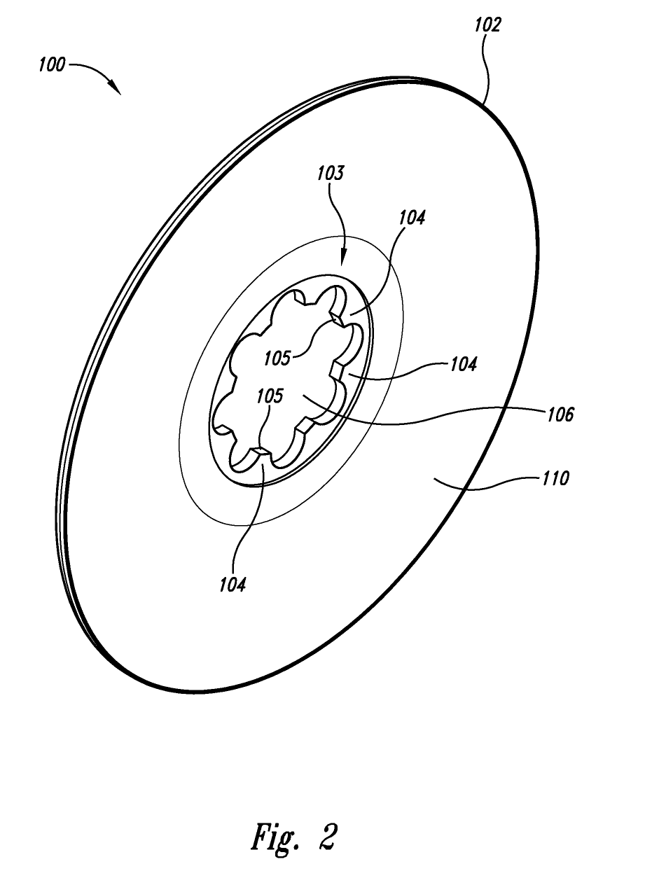

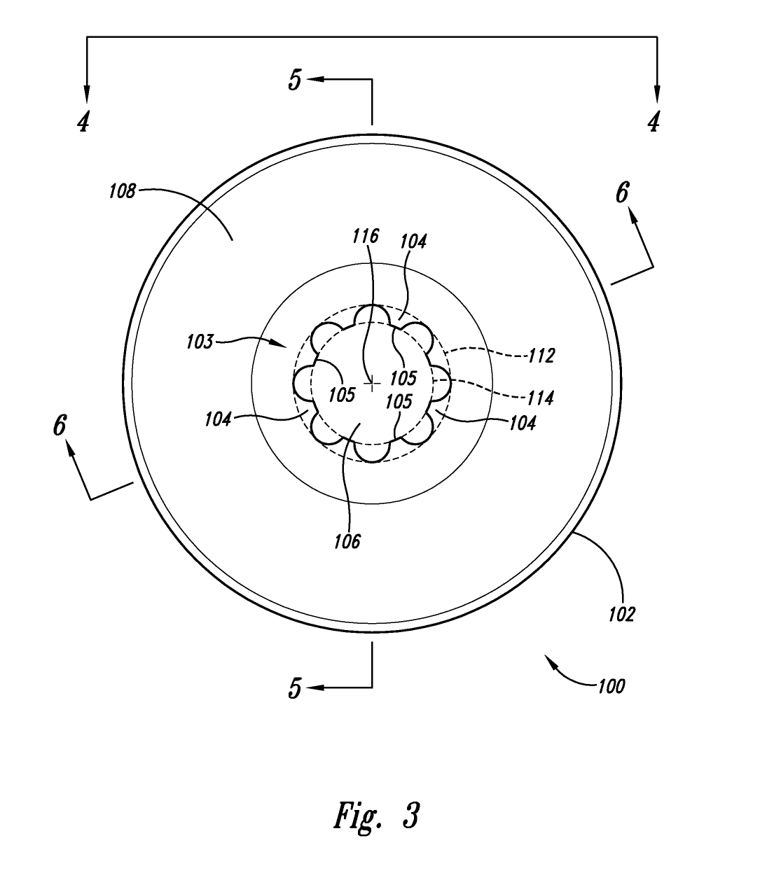

An exemplary enhanced cover plate 100 is depicted in FIG. 1 as having a plate body 102, a flexible portion 103 including flexible members 104 with end portions 105 and an opening 106. The plate body 102 has a front surface 108 and a rear surface 110 shown in FIG. 2. The opening 106 of the depicted implementation has a circular periphery 112 from which the flexible members 104 extend to border a circular portion 114 of the opening as a passageway. The flexible members 104 extend to position the enhanced cover plate 100 about a center 116 of the opening 106 when a pipe extends through the opening.

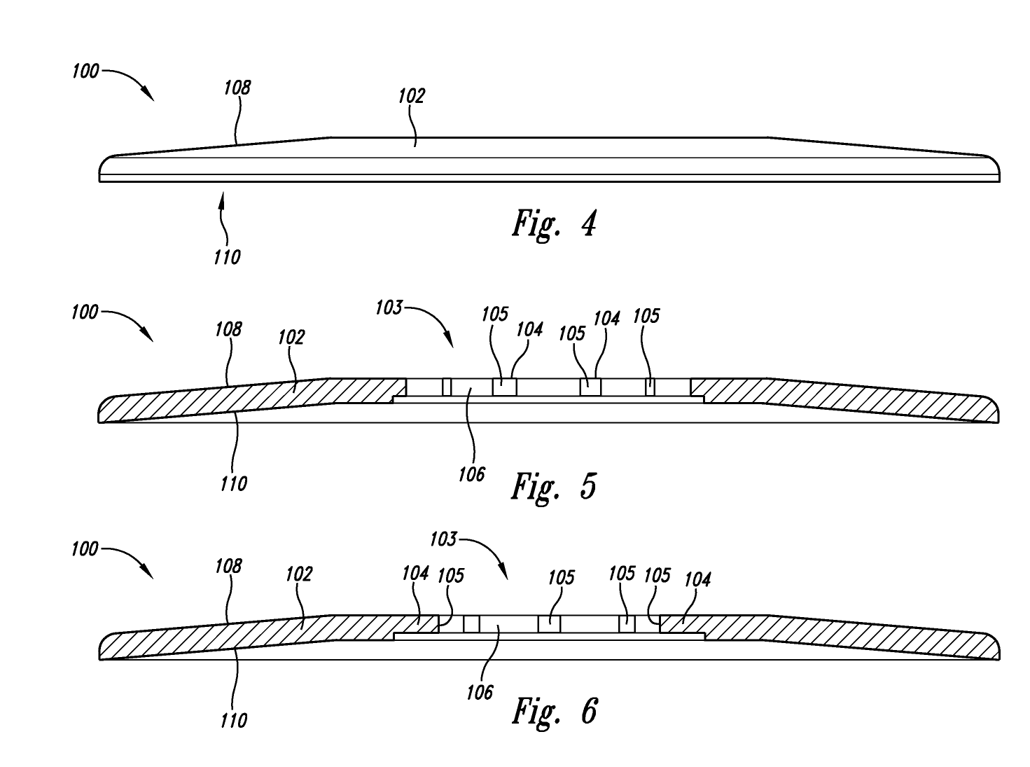

As shown in FIGS. 4-6, the front surface 108 of the depicted plate body 102 has a convex surface and the rear surface 110 has a concave surface. The plate body 102 is shown to have a greater thickness than that of the flexible members 104.

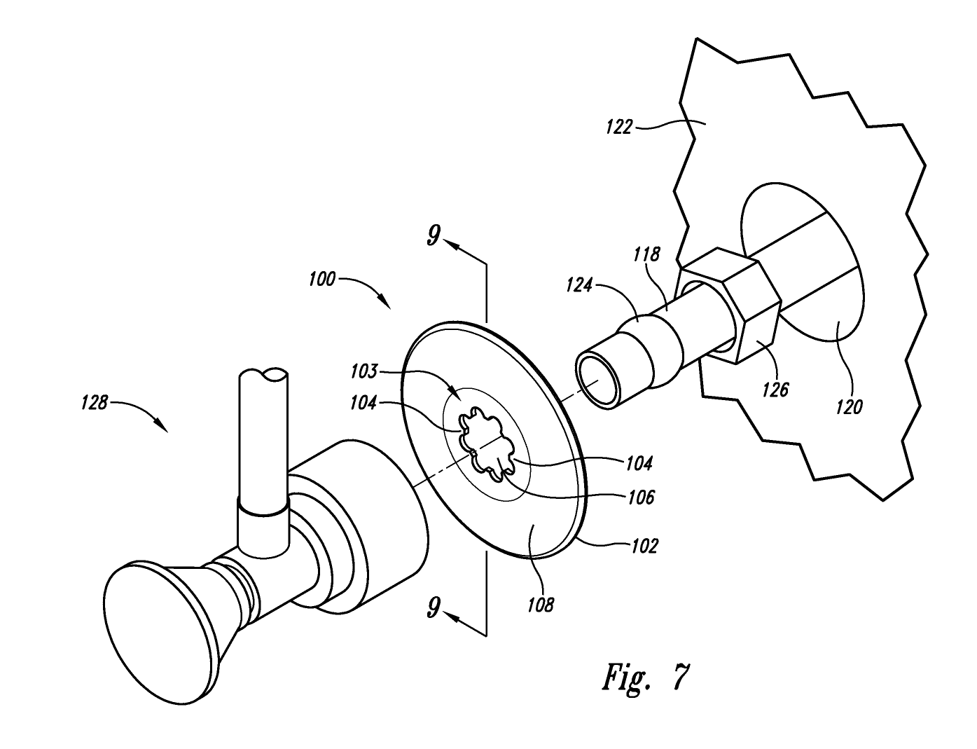

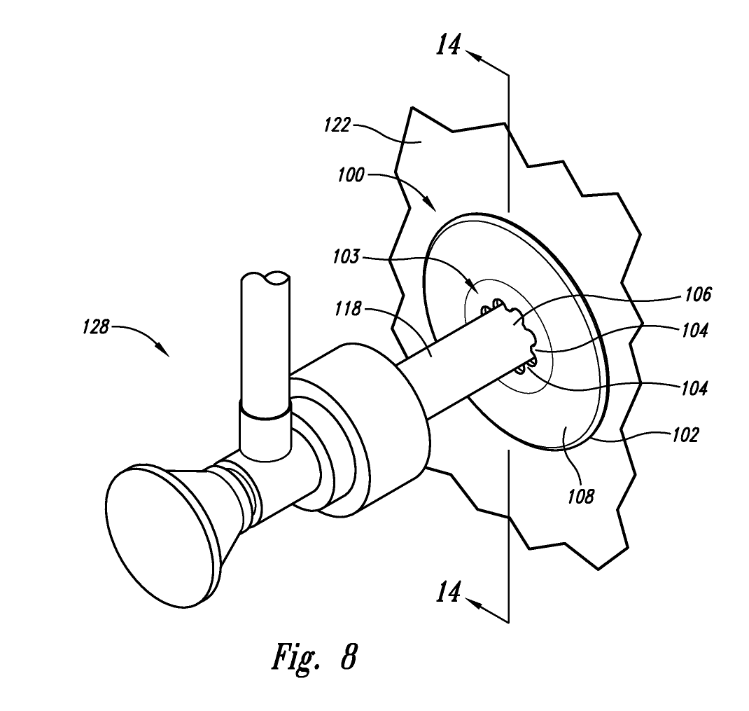

An exemplary installation shown in FIG. 7 in an initial position involves a pipe 108 protruding through a hole 120 in a wall 122. The pipe 118 has a compression ferrule 124 affixed thereto and a compression nut 126 slidaably coupled thereto. The compression ferrule 124 and the compression nut 126 are typically used for coupling of an abandoned compression valve (not shown) with the pipe 118. The exemplary installation includes a push-on valve 128 that is to be affixed to the pipe 118 as a replacement for a compression valve. As depicted, any prior installed cover plate has been removed, but the compression ferrule 124 and the compression nut 126 that typically would have been used for prior coupling of the abandoned compression valve has been left on the pipe 118.

The exemplary installation is shown in FIG. 8 in an installed position with the nut located inside of the wall 122 and the enhanced cover plate 100 pushed against the wall 122 to cover the hole 120 and to hide the nut. The push-on valve 128 is also shown secured on to the pipe 118.

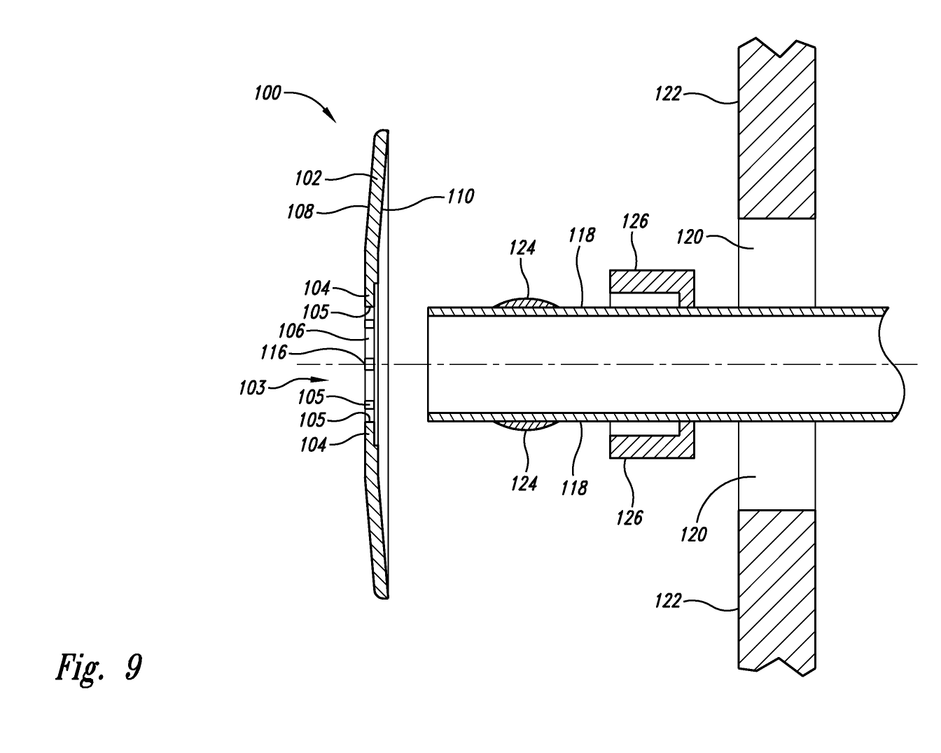

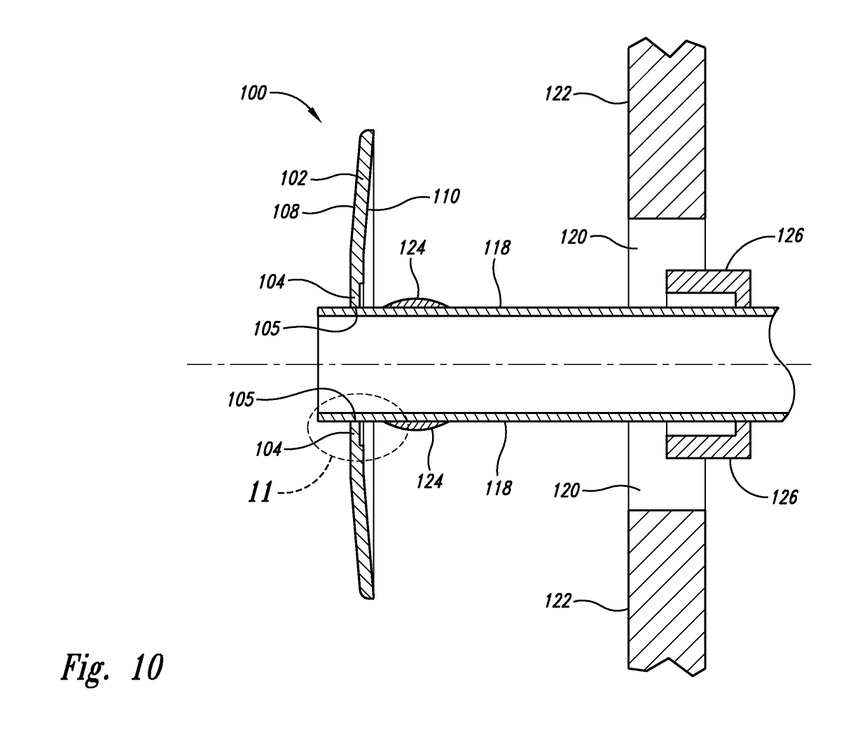

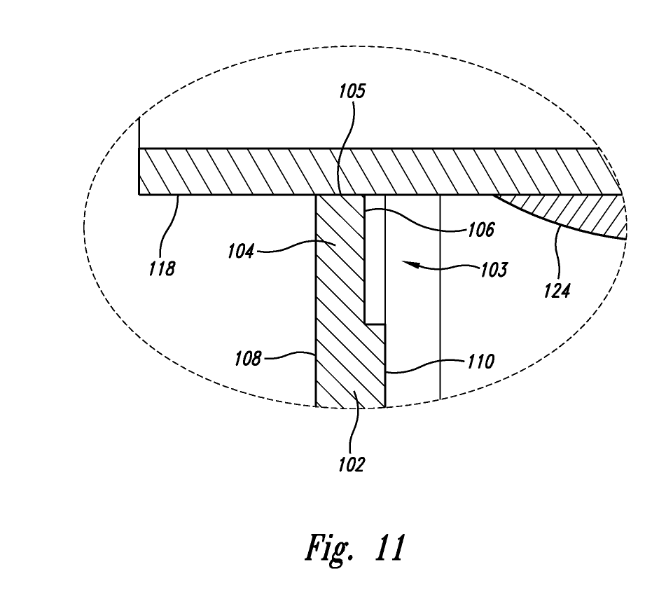

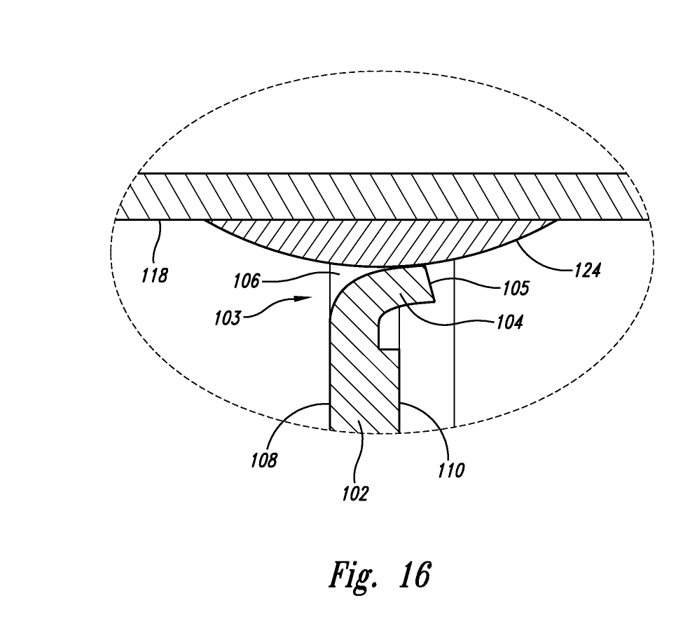

Sectional views of the enhanced cover plate 100 are shown in FIG. 9 through FIG. 16 at various stages of installation of the enhanced cover plate. As depicted in the FIG. 9, the enhanced cover plate 100 is positioned prior to engagement with the pipe 118. As depicted in FIG. 10, the enhanced cover plate 100 is positioned as initially engaging the pipe 118 with the end portions 105 of the flexible members 104 in contact with the pipe 118, as better shown in FIG. 11. In this depicted implementation, the circular portion 114 of the opening 106 bordered by the end portions 105 serving as a passageway for the pipe 118 is approximately the outer diameter of the pipe.

In alternative implementations, the flexible members 104 can be spaced away from the pipe a relatively small distance while still blocking view of the hole 120 and the nut 126 located behind the wall 122. In other alternative implementations, the flexible members 104 can be flexed to allow for a passageway that is larger than the circular portion 104 of the opening to accommodate a pipe (not shown) with a larger outer diameter than the depicted pipe 118. In other implementations, the flexible members can be differently shaped and spaced to allow for non-circular shaped passageways. In other implementations, the flexible portion 103 can have a flexible portion configured to accommodate flexible non-member portions.

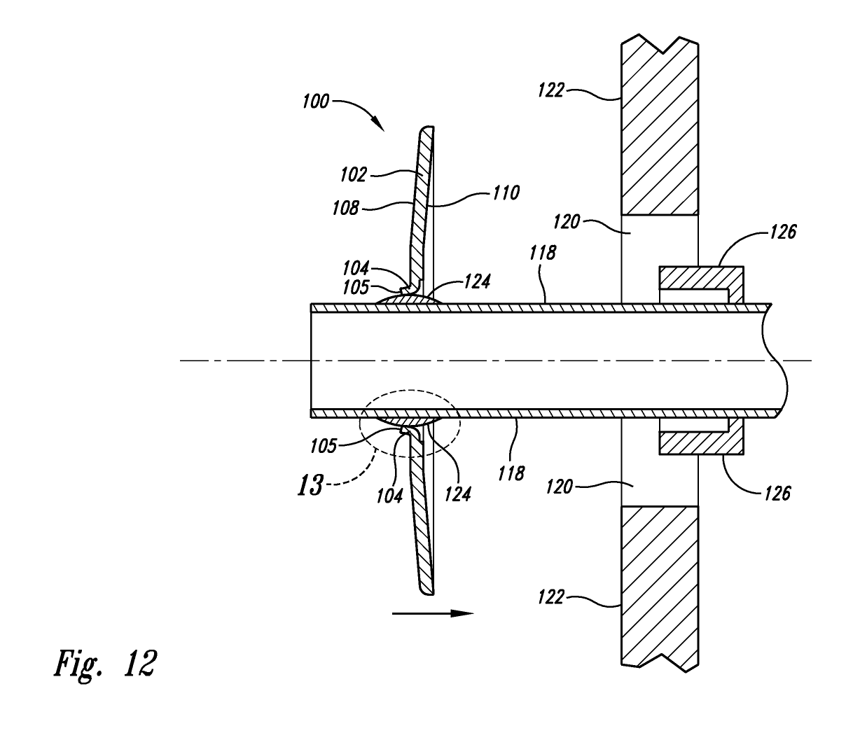

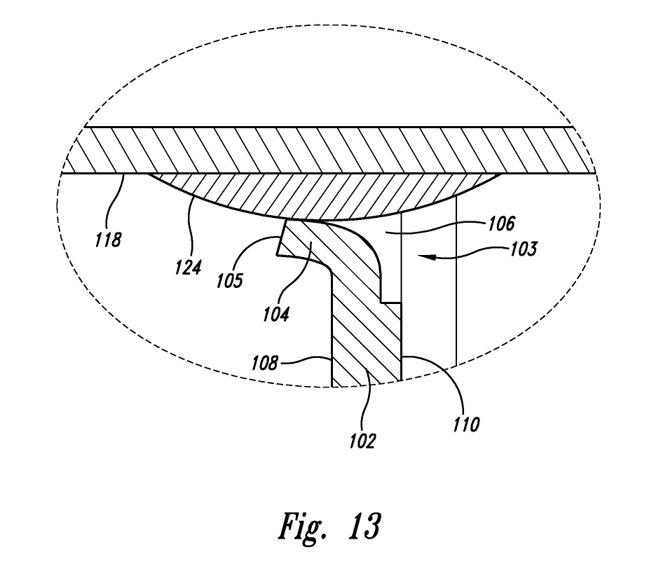

As depicted in FIG. 12, the enhanced cover plate 100 is positioned in an intermediate position while engaged with the compression ferrule 124. In this intermediate position the flexible members 104 are in a flexed position (better shown in FIG. 13) to allow for a passageway that is larger than the circular portion 104 of the opening 106 to accommodate the maximum outer diameter of the compression ferrule 124 as the enhanced cover plate 100 is slid over the compression ferrule to be located on the wall side of the compression ferrule.

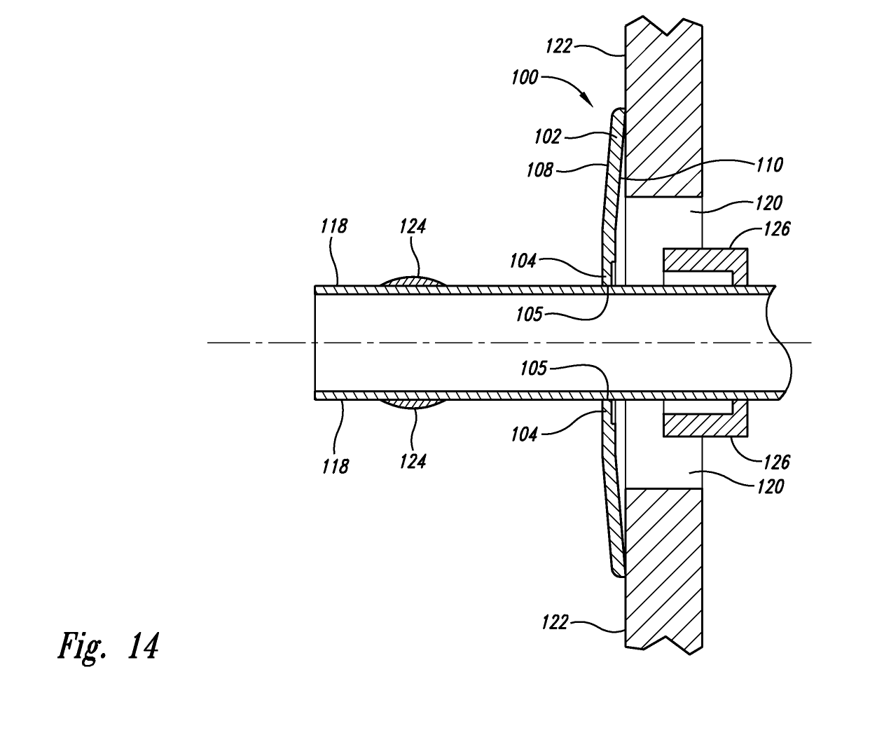

As depicted in FIG. 14, the enhanced cover plate 100 is positioned in an installed position with the rear surface 110 of the enhanced cover plate being positioned adjacent the wall 122. In this installed position, the enhanced cover plate 100 is able to cover the hole 120 in the wall 122 and to also cover the nut 126 that is located in an interior position of the wall also shown in FIG. 14.

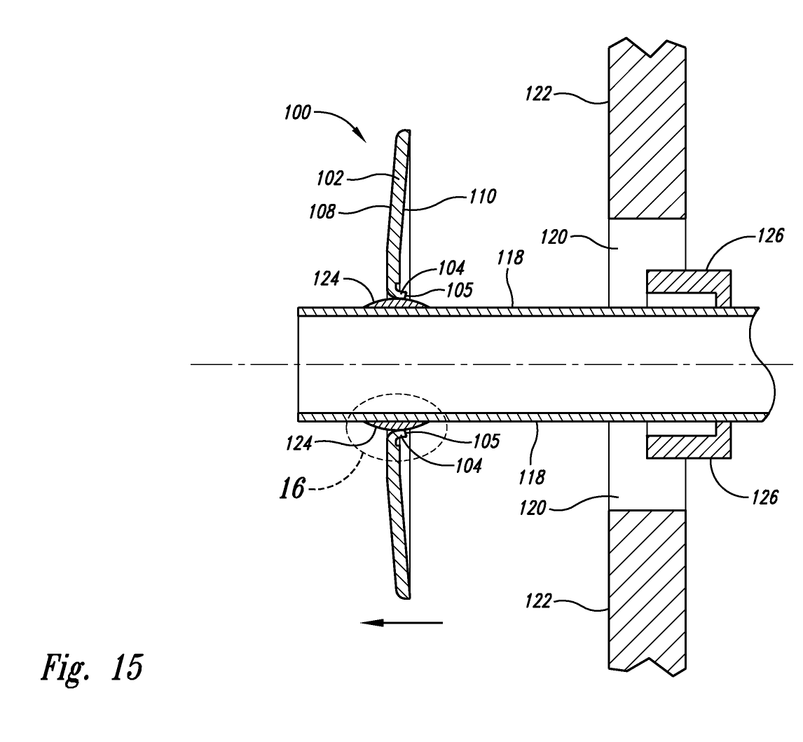

As depicted in FIG. 15, the enhanced cover plate 100 is capable of being removed from the installed position by being slid back over the compression ferrule 124 away from the wall 122 to be removed from the pipe 118.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A cover plate comprising:
a plate body;
an opening having a periphery and surrounded by the plate body; and
a plurality of members flexibly coupled to the plate body along portions of the periphery of the opening to allow for elastic movement of the members between a first position and a second position, the members in the first position extending from the plate body into the opening to define a first passageway to receive a pipe through the opening, the members in the second position extending from the plate body into the opening to define a second passageway, the second passageway being larger than the first passageway.

2. The cover plate of claim 1 wherein the members are spaced along the periphery of the opening with gaps between adjacent members.

3. The cover plate of claim 1 wherein the second passageway is larger than the first passageway by having a larger width.

4. The cover plate of claim 1 wherein the second passageway is larger than the first passageway by having a larger diameter.

5. The cover plate of claim 1 wherein the first passageway is sized to allow a pipe to be received through the opening and the second passageway is sized to allow the pipe and a compression ferrule coupled thereto to be received through the opening.

6. The cover plate of claim 1 wherein the members extend radially and axially inwardly from the periphery of the opening.

7. The cover plate of claim 1 wherein each of the members have an end and the ends are positioned to border a circular portion of the opening.

8. The cover plate of claim 1 wherein the members each have ends and each have a width that narrows toward the end.

9. The cover plate of claim 1 wherein the plate body has a first thickness and the members each have a second thickness, the first thickness being greater than the second thickness.

10. The cover plate of claim 1 wherein the cover plate has a center and the opening has a center and the center of the opening is the center of the cover plate.

11. The cover plate of claim 1 wherein the plate body has a curvature.

12. The cover plate of claim 1 wherein the cover plate has a circular outer periphery.

13. A cover plate comprising:
a plate body;
an opening having a periphery and surrounded by the plate body; and
a flexible portion extending from the plate body along portions of the periphery of the opening, the flexible portion being elastically moveable between a first position and a second position, the flexible portion in the first position defining a first passageway, the flexible portion in the second position defining a second passageway, the second passageway being larger than the first passageway.

14. The cover plate of claim 13 wherein the plate body has a first thickness and the flexible portion has a second thickness, the first thickness being greater than the second thickness.

15. The cover plate of claim 13 wherein the opening includes a center and the flexible portion extends inward toward the center of the opening.

16. The cover plate of claim 13 wherein the plate body has a curvature and the flexible portion is flat.

17. The cover plate of claim 13 wherein the cover plate has a circular outer periphery.

18. The cover plate of claim 13 wherein the flexible portion includes members spaced along the periphery of the opening with gaps between adjacent members.

19. The cover plate of claim 13 wherein the first passageway is sized to allow a pipe to be received through the opening and the second passageway is sized to allow the pipe and a compression ferrule coupled thereto to be received through the opening.

20. The cover plate of claim 13 wherein the flexible portion extends radially and axially inwardly from the periphery of the opening.

21. The cover plate of claim 13 wherein the flexible portion has end portions that border a circular portion of the opening.

22. The cover plate of claim 13 wherein the flexible portion includes narrowed end portions.

23. The cover plate of claim 13 wherein the cover plate has a center and the opening has a center and the center of the opening is the center of the cover plate.

24. For a pipe having a ferrule coupled thereto, a cover plate comprising:
a plate body;
an opening having a periphery and surrounded by the plate body; and
a plurality of members flexibly coupled to the plate body along portions of the periphery of the opening to allow for elastic movement of the members between an first position and a second position, the members in the first position extending from the plate body into the opening to define a first passageway to receive the pipe through the opening, the members in the second position extending from the plate body into the opening to define a second passageway to receive the ferrule and the pipe through the opening when the members are in the second position.

25. For a pipe having a ferrule coupled thereto, a cover plate comprising:
a plate body;
an opening having a periphery and surrounded by the plate body; and
a flexible portion extending from the plate body along portions of the periphery of the opening, the flexible portion being elastically moveable between a first position and a second position, the flexible portion in the first position defining a first passageway to receive the pipe through the opening, the flexible portion in the second position defining a second passageway to receive the ferrule and the pipe through the opening when the members are in the second position.

26. A method for covering a hole in a wall, the hole having a pipe extending therethrough, the pipe having a ferrule coupled thereto, the pipe having an end portion, the method comprising:
placing the end portion of the pipe through an opening in a cover, the opening bounded by a flexible portion in a first position;
sliding the cover along the pipe with the flexible portion being in the first position;
pushing the ferrule through the opening by placing the flexible portion in a second position to increase size of the opening; and
placing the cover adjacent the wall to cover the hole in the wall.
